(19) United States
(12) Patent Application Publication
(10) Pub. No.: US 2018/0229187 A1
(43) Pub. Date: Aug. 16, 2018

(54) HOLLOW FIBER MEMBRANE MODULE INCLUDING CONCENTRATE DISTRIBUTOR

(71) Applicant: Dow Global Technologies LLC, Midland, MI (US)

(72) Inventors: Liangzhou Fan, Huzhou (CN); Ying Qi Yao, Huzhou (CN); Shanke Zhang, Huzhou (CN)

(73) Assignee: Dow Global Technologies LLC, Midland, MI (US)

(21) Appl. No.: 15/752,019

(22) PCT Filed: Oct. 8, 2015
(86) PCT No.: PCT/CN2015/091465

§ 371 Date: Feb. 12, 2018

(51) Int. Cl. B01D 63/02

(52) U.S. Cl. CPC B01D 63/024; B01D 2313/12; B01D 2313/21

(57) ABSTRACT

A filter module (10) including: a housing (12) extending between an opposing first (14) and second end (16) and defining an inner chamber (18), a plurality of hollow fiber membranes (20) located within the inner chamber, a tubesheet (26) including the ends (24) of the hollow fibers encased but open within a block of potting material, an end cap (30) secured to the end of the housing and including: a permeate fluid outlet (32) in fluid communication with the ends of the hollow fibers, and a concentrate fluid outlet (34) in fluid communication with the inner chamber, wherein the permeate and concentrate fluid outlets are axially aligned, and a concentrate distributor (36) including: an annular ring (38) located adjacent to the second end of the housing, at least one aperture (40) in fluid communication with the inner chamber, and an annular concentrate passageway (42) extending from the aperture and concentrically about the permeate tubesheet to the concentrate fluid outlet of the permeate end cap.

### FIELD

The invention is directed toward hollow fiber (capillary) membrane modules.

### INTRODUCTION

Hollow fiber membrane modules are used in a wide variety of applications ranging from industrial processing of liquids and gases to residential purification of drinking water. These types of filter modules typically include a tubular-shaped housing defining an inner chamber with one or more fluid ports located near each end of the housing. A plurality (e.g. hundreds) of aligned semi-permeable hollow fiber membranes are orientated axially within the inner chamber. The ends of the hollow fibers may be sealed from the inner chamber by way of tubesheet using well known “potting” techniques wherein one or both ends of the hollow fibers remain open and in fluid communication with one or more outer chambers formed within the end cap assembly. See for example U.S. Pat. No. 8,506,808. In operation, pressurized feed fluid enters the module via an inlet located at one end of the module. Fluid passing through the walls of the hollow fiber membrane (“permeate”) and entering into the fiber's lumen exits the module by way of a separate fluid port, typically located at the opposite end of the module from where feed fluid enters. Fluid not passing through the walls of the membrane exits the module as “concentrate.” Examples of such modules include: DOW™ Ultrafiltration module models: SFP-2860, SFP-2880, SFD-2860 and SFD-2880 available from The Dow Chemical Corporation. Additional examples are described in U.S. Pat. No. 8,261,919.

It can be advantageous to position fluid inlets and outlets of modules in an axial direction rather than porting from the side (radial direction). This has been traditionally accomplished by providing one or more pipes or apertures extending through the tubesheet such that concentrate or feed fluid flows axially through an end of the module. Unfortunately, the area occupied by such pipes or apertures extending through the tubesheet significantly reduces the fiber packing density of the module and can result in stagnant or low fluid flow regions within the module requiring more frequent module cleaning.

### SUMMARY

The present invention is directed toward fluid filter modules and methods for making and using the same. In a preferred embodiment, the invention includes a module having permeate and concentrate fluid outlets that are axially aligned to direct fluid axially from the module along with a concentrate distributor that allows concentrate fluid to bypass concentrically around a tubesheet and more evenly distribute fluid flow to mitigate stagnant flow regions within the module.

With reference to the Figures, a preferred embodiment the invention includes a filter module (10) comprising:
i) a tubular-shaped housing (12) extending along an axis (X) between an opposing first (12) and second (16) end and defining an inner chamber (18);
ii) a plurality of hollow fiber membranes (20) located within the inner chamber (18) and having first ends (22) located adjacent to the first end (14) of the housing (12) and second ends (24) located adjacent to the second end (16) of the housing (12);
iii) a permeate tubesheet (26) comprising the second ends (24) of the hollow fiber membranes (20) encased but open (i.e. such that permeate fluid may exit the second ends (24) of the hollow fibers) within a block of potting material (e.g. epoxy, polyurethane, silicone, etc.) having a configuration corresponding to the inner periphery of the housing (12) which forms a fluid seal therewith such that fluid passage through the permeate tubesheet (26) is limited to the second ends (24) of the hollow fiber membranes (20);
iv) a feed fluid inlet (28) in fluid communication with the inner chamber (18) of the module (10);
v) an end cap (30) secured to the second end (16) of the housing (12) and comprising:
   a) a permeate fluid outlet (32) in fluid communication with the second ends (24) of the hollow fiber membranes (20), and
   b) a concentrate fluid outlet (34) in fluid communication with the inner chamber (18), wherein the permeate and concentrate fluid outlets (32, 34) are axially aligned to direct fluid axially from the module (10); and
a concentrate distributor (36) comprising:
   a) an annular ring (38) located adjacent to the second end (16) of the housing (12),
   b) at least one aperture (40) in fluid communication with the inner chamber (18), and
   c) an annular concentrate passageway (42) extending from the aperture (40) and concentrically about the permeate tubesheet (26) to the concentrate fluid outlet (34) of the end cap (30).

In another preferred embodiment, the concentrate distributor (36) comprises a plurality of apertures (40, 40′) spaced about the periphery of an annular base (38). In yet another embodiment, the concentrate distributor (36) further comprises a base assembly (44) secured concentrically about the second end (16) of the housing (12) and including radially extending threads (46) adapted for securing the end cap (30) to the housing (12). The base assembly (44) can be molded together with the concentrate distributor (36). The module may further include a permeate cap (58) secured to the concentrate distributor (36) and defining a permeate chamber (54) in fluid communication with the permeate fluid outlet (32) and the second ends (24) of the hollow fiber membranes (20). The module (10) may also include a feed tubesheet (48) including the first ends (22) of the hollow fiber membranes (20) encased and sealed within a block of potting material having a configuration corresponding to an inner periphery of the housing (12) and further including at least one feed fluid passageway (50). A feed end cap (52) may be secured to the first end (14) of the housing (12) with the feed fluid inlet (28) in in fluid communication with the feed fluid passageway (50) to the inner chamber (18) for feed fluid to enter the module (10).

### BRIEF DESCRIPTION OF THE DRAWINGS

The invention and various embodiments may be better understood by reference to the detailed description and accompanying figures. The Figures are provided to facilitate description and are not necessarily to scale. Within these sections, like reference numerals refer to like elements.

FIG. 1 is a cross-sectional elevational view of a fluid filter module according to one embodiment of the invention.

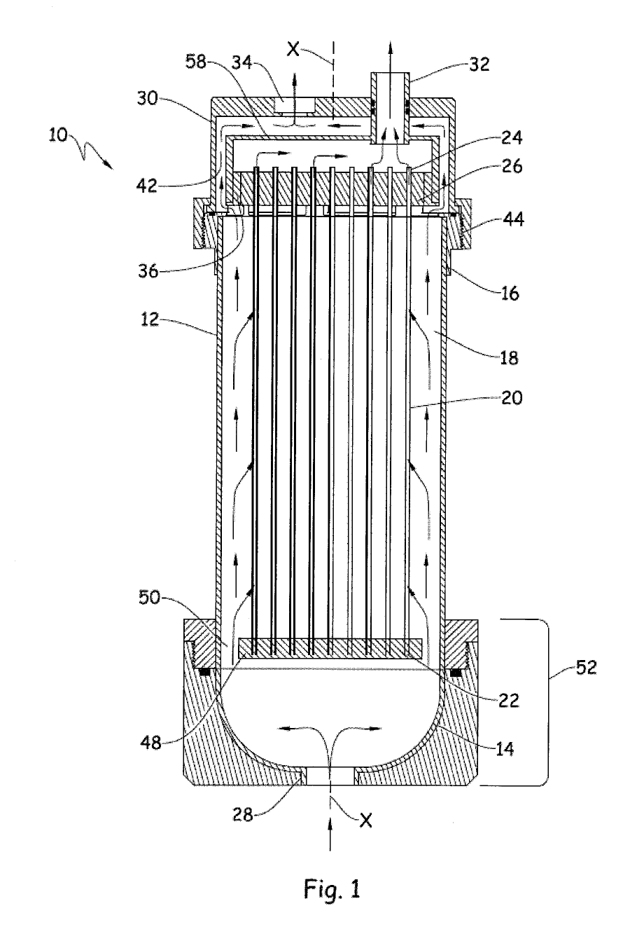

FIG. 2 is a partially cut-away, partially assembled, perspective view of the second end of the filter module of FIG. 1 with hollow fiber membranes removed to facilitate description.

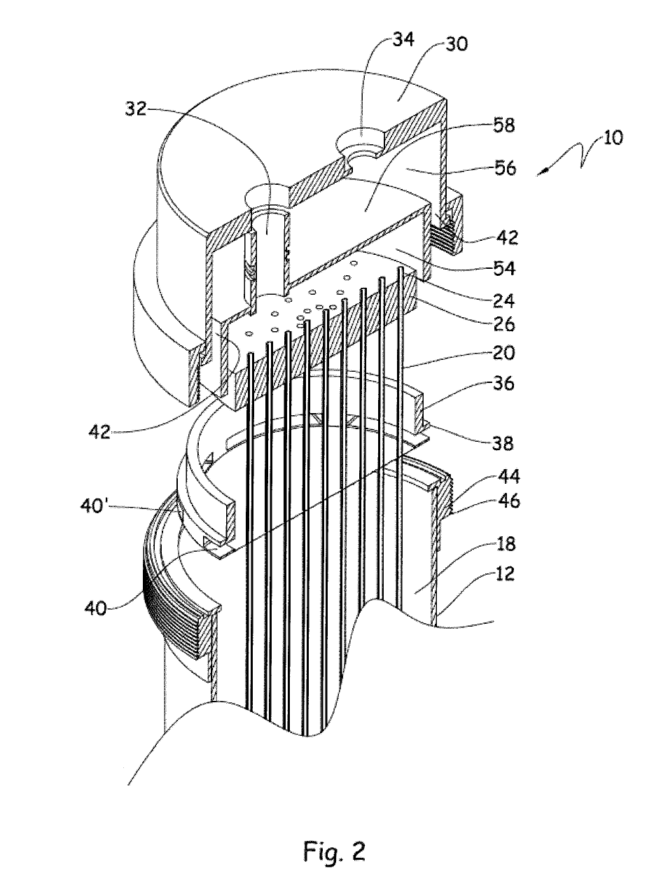

### DETAILED DESCRIPTION

In further reference to the Figures, during operation pressurized feed fluid (e.g. untreated water) enters the inner chamber (18) by way of fed fluid inlet (28) and flows along the length of the hollow fiber membranes (20). A portion of the feed fluid passes through the walls of membranes (“permeate”) and flows along their lumen to a permeate chamber (54) located within the end cap (30) and where it ultimately exits the module (10) by way of the permeate fluid outlet (32). Fluid that is unable to pass through the membranes (“concentrate”) flows radially outward through the aperture(s) (40, 40′) of the concentrate distributor (36) and concentrically about the permeate tubesheet (26) via the annular concentrate passageway (42) to a concentrate chamber (56) located within the end cap (30). The concentrate ultimately exits the module (10) by way of the concentrate fluid outlet (34). Fluid flow patterns are as generally shown by arrows. The concentrate distributor (36) allows the concentrate to bypass around rather than through the permeate tubesheet (26). As a consequence, the tubesheet may include a higher fiber packing density. Additionally, the use of a plurality of spaced apertures (40, 40′) evenly distributes concentrate fluid such that stagnate fluid areas are reduced.

The subject filter module may be used in a wide range of applications including but not limited to microfiltration (MF), ultrafiltration (UF), nanofiltration (NF) and reverse osmosis (RO) and pervaporation. Similarly, a wide variety of feed fluids may be treated with the subject filter module, e.g. produced water from secondary oil recovery, waste water from industrial processes, municipal waste water, water for potable use, recycled water from washing/rinsing procedures, water requiring pre-treatment prior to subsequent treatment (e.g. via RO, ion exchange, carbon filtration, etc.), water from food, beverage and dairy processes, etc.

In a preferred embodiment the filter module includes a tubular-shaped (e.g. an elongated shell having a length greater than its width), housing extending along an axis between an opposing first and second end and defining an inner chamber. In one preferred embodiment, the outer periphery of the filter module is cylindrically-shaped having a circular cross-section. In an alternative embodiment, the housing may have a polygonal cross-section. The housing may be constructed from a wide variety of materials, e.g. plastics, ceramics, metals, etc., however, in one set of preferred embodiments the housing is made from an injection moldable plastic such as polyvinyl chloride (PVC) or acrylonitrile butadiene styrene (ABS).

The module includes a plurality (e.g. hundreds) of semi-permeable hollow fiber membranes (“fibers”) located within the inner chamber. The fibers include a semi-permeable wall surrounding a lumen which extends between an opposing first and second end. The fibers are preferably axially aligned with their first ends located adjacent to a first end of the housing and their second ends located adjacent to the second end of the housing. In an alternative embodiment, both ends of the fibers are located at a common end of the housing with the bulk of the fiber extending between the opposing ends of the housing in a classic “U” shaped configuration. Representative semi-permeable hollow fiber membranes include those made from: polysulfones, polyether sulfones, polyvinylidene fluoride, polyamides, polyacrylonitrile, polypropylene, etc.

One or both of the opposing ends of the fibers may be sealed from the inner chamber as part of a tubesheet. The tubesheet may be formed by well-known “potting” techniques (e.g. using epoxy, polyurethane, silicone, etc.) wherein one or both ends of the hollow fibers remain open and in fluid communication with one or more outer chambers formed within an end cap assembly. See for example U.S. Pat. No. 8,506,808 and the references cited therein. In an alternative embodiment, one end of the fibers forms part of a tubesheet with the opposing fiber ends are individually sealed in a manner that allows individual fibers to be free to move relative to another. In yet another embodiment, both ends of the fibers are sealed within a common tubesheet with the bulk of the fiber extending between the opposing ends of the housing in a classic “U” shaped configuration.

The fluid ports are preferably included as part of permeate and feed end caps which are secured to the opposing ends of the module. However, the module may include side or radial ports located between the ends of the module, and which provide direct access to the inner chamber.

End cap assemblies are preferably concentrically disposed about the end of the housing. In preferred embodiments, the end cap assemblies include a base having inner periphery with a matching or complementary configuration with that of the outer periphery of the end of the housing such that the base can be slid, tightly fitted and preferably sealed about the end of the housing. Depending upon the materials of construction, the base may be secured to the housing via mechanical means, e.g. pressure fit, clamps, matching threads, etc., or may be adhered such as by way of ultrasonic welding, spin welding, adhesive, etc., or combinations of such techniques. The end caps may be constructed from a wide variety of materials, e.g. plastics, ceramics, metals, etc., however, in a preferred set of embodiments the housing is made from an injection moldable plastic such as polyvinyl chloride (PVC) or acrylonitrile butadiene styrene (ABS). The end caps may include additional fluid inlets and outlets of various orientations. In a preferred embodiment, the end cap assembly includes fluid port(s) extending axially outward from the base.

While described as operating “outside-in” mode (i.e. feed liquid contacting the outside of the hollow fiber membranes), the module may alternatively be operated in “inside-out” mode wherein feed fluid is introduced inside the lumen portion of the hollow fibers. While feed fluid is typically introduced into the module under pressure, the module may alternatively be operated by applying negative pressure to the permeate side of the semi-permeable membrane, or a combination of both positive and negative pressure.

Many embodiments of the invention have been described and in some instances certain embodiments, selections, ranges, constituents, or other features have been characterized as being “preferred”. The designation of a feature as being “preferred” should not be interpreted as deeming such features as an essential or critical aspect of the invention. While shown as including an end cap assembly at both ends of the housing, the subject module includes embodiments which include only one end cap assembly.

What is claimed is:

1. A filter module (10) comprising:
i) a tubular-shaped housing (12) extending along an axis (X) between an opposing first (14) and second end (16) and defining an inner chamber (18);
ii) a plurality of hollow fiber membranes (20) located within the inner chamber (18) and having first ends (22) located adjacent to the first end (14) of the housing (12) and second ends (24) located adjacent to the second end (16) of the housing (12);
iii) a permeate tubesheet (26) comprising the second ends (24) of the hollow fiber membranes (20) encased but open within a block of potting material having a configuration corresponding to the inner periphery of the housing (12) which forms a fluid seal therewith such that fluid passage through the permeate tubesheet (26) is limited to the second ends (24) of the hollow fiber membranes (20);
iv) a feed fluid inlet (28) in fluid communication with the inner chamber (18) of the module;
v) an end cap (30) secured to the second end (16) of the housing (12) and comprising:
a) a permeate fluid outlet (32) in fluid communication with the second ends (24) of the hollow fiber membranes (20), and
b) a concentrate fluid outlet (34) in fluid communication with the inner chamber (18), wherein the permeate and concentrate fluid outlets (32, 34) are axially aligned to direct fluid axially from the module (10); and
vi) a concentrate distributor (36) comprising:
a) an annular ring (38) located adjacent to the second end (16) of the housing (12),
b) at least one aperture (40) in fluid communication with the inner chamber (18), and
c) an annular concentrate passageway (42) extending from the aperture (40) and concentrically about the permeate tubesheet (26) to the concentrate fluid outlet (34) of the end cap (30).

2. The module of claim 1 wherein the concentrate distributor (36) comprises a plurality of apertures (40, 40′) spaced about the periphery of annular ring (38).

3. The module of claim 1 wherein the concentrate distributor (36) further comprises a base assembly (44) secured concentrically about the second end (16) of the housing (12) and including radially extending threads (46) adapted for securing the end cap (30) to the housing (12).

4. The module of claim 1 further including a permeate cap (58) secured to the concentrate distributor (36) and defining a permeate chamber (54) in fluid communication with the permeate fluid outlet (32) and the second ends (24) of the hollow fiber membranes (20).

5. The module of claim 1 further comprising a feed tubesheet (48) comprising the first ends (22) of the hollow fiber membranes (20) encased and sealed within a block of potting material having a configuration corresponding to an inner periphery of the housing (12) and further including at least one feed fluid passageway (50).
